(19) United States
(12) Patent Application Publication
(10) Pub. No.: US 2008/0053607 A1
(43) Pub. Date: Mar. 6, 2008

(54) Process for Making Laminated Angle Board with In-Line Slitter

(76) Inventor: Tom Stewart, Arlington, TX (US)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 11/470,249

(22) Filed: Sep. 5, 2006

(51) Int. Cl. B32B 37/12; B32B 38/04

(52) U.S. Cl. 156/264; 156/269

(57) ABSTRACT

An improved process of making laminated angle board wherein a slitter is placed in-line with the process such that various rolls of differing widths of scrap paper can be more easily and economically used to create the plurality of strips that are laminated together to make the angle board. The in-line slitter is either in an approximately horizontal configuration, either parallel or perpendicular to the production line, or in a novel approximately vertical configuration.

### BACKGROUND OF THE INVENTION

1. Field of the Invention

This invention relates to a process for making laminated angle board and more particularly to a process of making laminated angle board wherein an in-line slitter is used to cut a roll of paper into strips of a desired width that are then generally aligned with each other and glued together.

2. Description of Related Art

Laminated angle board, also known as corner board, is a common product throughout the United States and the world and is used as a support mechanism for the shipment of goods, including when goods are shipped via strech-wrapped or strapped pallets. Boxed goods are first stacked on a square pallet and an angle board is placed on each vertical edge of the stack. For example, if boxed goods are stacked four feet high on a square pallet, then four angle boards are used, one for each corner and each is a four foot section. The metal straps or stretch-wrap used to secure the boxes on the pallet are placed around the angle boards. The angle boards provide the stack with support and protect the boxed goods during shipment.

The standard process of making laminated angle board is known in the prior art and is practiced by various paper product companies. Laminated angle board is made by gluing multiple strips of paper together, folding the stiff layered-paper, or board, into a right angle along its length, and then cutting the angle board into a desired length. The width of the angle board is determined by the width of the strips of paper laminated together to form the board. For example, six-inch wide strips of paper are referred to as “3×3” angle board, because the six-inch laminated board is folded down the middle into a right angle having two, three-inch portions.

The standard process of making laminated angle board begins by gathering three or more rolls of paper that have been precut to the desired width of the angle board. The number of layers of paper needed to form the angle board depends on the thickness of the paper used and the desired thickness of the angle board. The various rolls of paper are spaced apart on one or more racks. The length of the racks can be approximately sixty to seventy-five feet long. Each roll of paper is fed along various rollers into a cascading glue pot where glue is applied to one side of each layer of paper via the use of a hose positioned above the top of each layer. The layers of paper then pass through an alignment device and are pressed together, or laminated, into one solid thicker piece. When manufacturing thinner pieces, glue application maybe removed from one or more internal layers resulting in two or more separate solid laminates being produced simultaneously.

The flat board then is passed through a forming station wherein a drive wheel pulls the board through a plurality of forming rolls. These forming rolls form the board into the desired angle, preferably a right angle. The drive wheel provides sufficient pulling power to pull all the paper off the individual rolls, across the rollers, through the glue pot and then through the forming station. After the angle board leaves the forming station, it is cut to its desired length.

There are several disadvantages with the prior art process of making laminated angle board. One disadvantage is that before the process is begun, a large number of rolls of paper of the desired width must be acquired. Another disadvantage is the amount of space required to place the various rolls of paper on racks. The rolls generally come from paper rejected by paper mills because of slight irregularities or overproduction. The plant can buy a roll of paper with a large width, which might have been a rejected roll from a gypsum board mill for example, and slit the paper into the desired widths. The plant can also buy rolls with the desired width from paper mills that produce excess paper in the forms of side trims. For example, if a mill runs a paper machine that is one hundred inches wide and takes an order for ninety-four inch wide rolls, then the remaining side trim of six inches may be sold to an angle board plant. One problem is that the larger side trims from other mills that are wider than is needed for the largest desired angle board, but are not as wide as a full width roll, are not able to be used by the angle board plants. It is not economical for an angle board plant to buy for example a twelve inch roll and slit it into two six-inch rolls because of the labor cost involved in running the slitter. It is only economical to run the slitter for a full width roll. Currently there is no market for these larger side trims, so if an angle board plant was able to use them, a great advantage would be imparted to angle board manufacturers.

Another disadvantage with the standard process of making laminated angle board is that it is extremely difficult to change between making various widths of angle board. Because all the layers of paper used are precut, each of the pre-slit rolls must be removed from the racks. All rolls of the new width have to be placed on the racks and then fed through all the rollers, through the glue pot and then through the forming station. Valuable production time is lost and labor costs are incurred as the changeover process is taking place. Also, the plant must have in inventory all of the rolls of the new desired width before a change can be made. This increases the necessary inventory that a plant must maintain.

It is therefore desirable to have an angle board making process that can use all widths of side trim paper, use less space and is easy to change between the various widths of angle board produced.

### SUMMARY OF THE INVENTION

The present invention is an improved process for making laminated angle board that overcomes the disadvantages of the prior art and previously standard way of making it. The improved process involves incorporating a slitter in-line with the standard production process rather than only using precut widths, which creates a continuous, direct feed process. By placing a slitter in-line, side trim of all widths can be used in the process, and the widths of angle board produced can be changed much easier, which reduces the time needed, space required and labor costs incurred.

The improved process for making laminated angle board is achieved by placing one or more slitters in-line with the overall lamination process, which allows the strips of paper to enter the lamination process by direct feed after being slit. One or a plurality of slitters may be used. The number of in-line slitters is determined by the number of layers needed to reach the desired thickness of the angle board. Each slitter can produce various widths, and depending on the desired width of the angle board it may be desirable to employ an additional slitter.

Either large, wide rolls of paper or a plurality of narrower rolls are placed on the in-line slitter until the overall width of the paper on the slitter is sufficient to be cut into the desired number of strips at the desired width. The knives on the in-line slitter are adjustable, either manually or through computer numerical controls. Once the rolls of paper are loaded onto the slitter, the knives are adjusted to slit the paper into strips of the desired width. As the strips are cut, they pass along the rollers, and are aligned with each other before entering the cascading glue pot. If desired, a strip from a separate roll that has been pre-printed with a logo or trademark and precut to the desired width can be aligned on top of the layers that came directly from the in-line slitter. Also, one or more pre-slit rolls may be added to achieve the exact caliper of finished product desired.

In one embodiment, the rolls of paper and the knives of the in-line slitters are horizontal as is customary for slitters now. The paper strips as they come off the rolls should be aligned on top of each other before entering the glue pot. How far each strip travels laterally to become aligned with the other strips determines how far away from the glue pot the slitter should be placed. It is preferred that the paper strips be moved laterally at a relatively small angle as measured from the horizontal. Paper strips from the outside of the rolls are required to move further laterally than are inside strips.

In one alternative embodiment, the rolls of paper and the knives of the slitter are placed approximately perpendicular to the production line. In this embodiment, the paper strips come off of the slitter flat and then pass over a turn bar, which twist the strips to a vertical orientation and turns them towards the glue pot (approximately ninety degrees). As the strips move towards the glue pot, over a course of a few feet, they return to a horizontal or flat alignment. Because the strips come off of the slitter perpendicular to the line, the turn bars can be placed in such a manner that the strips will run to a distance perfectly inline with the glue pot before being turned towards the glue pot. This allows the rolls to be placed within a few feet of the glue pot, thus making the production line much shorter and further reducing the amount of floor space occupied by the process. By placing the large rolls of paper perpendicular to the production line, it is also easier to replace the rolls as they run out because they would not be next to each other. If two large rolls are being used, the rolls could be placed on opposite sides of the production line, and the changing out of one would not interfere with the changing out of the other.

In further alternative embodiments, the rolls of paper and the knives of the slitter can be approximately vertical or any angle between vertical and horizontal. If in a vertical position, the strips of paper come off of the slitter in vertical alignment with each other allowing the slitter to be placed much closer to the glue pot, thus making the production line much shorter and further reducing the amount of floor space occupied by the process. After the strips of paper come off of the slitter, they are rotated approximately ninety degrees (from vertical to horizontal) before entering the glue pot. If the rolls of paper and the slitter are at a different angle, then the rotation of the strips will be less than ninety degrees.

### BRIEF DESCRIPTION OF THE DRAWINGS

The improved process of the invention is further described and explained in relation to the following figures of the drawings wherein:

FIG. 1 is a process flow diagram showing the improved process of making laminated angle board by incorporating an in-line slitter.

FIG. 2 is a perspective view of the improved process including the in-line slitter.

FIG. 3 is a perspective view of an alternative embodiment of the improved process wherein the in-line slitter is placed perpendicular to the production line.

FIG. 4 is a perspective view of an alternative embodiment of the improved process wherein the in-line slitter has been rotated approximately ninety degrees as compared to the process depicted in FIG. 2.

Like reference numerals are used to describe like parts in all figures of the drawings.

### DESCRIPTION OF THE PREFERRED EMBODIMENTS

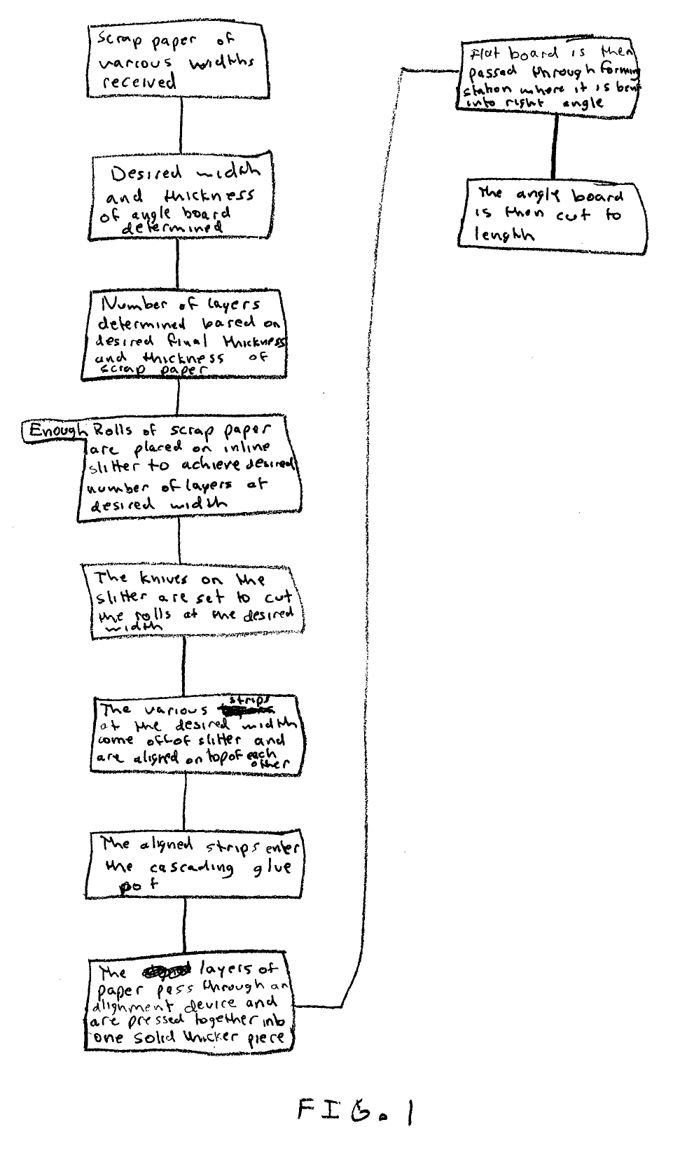

Referring to FIG. 1, a process flow diagram demonstrating the improved process for making laminated angle board is shown. Feedstock for the process is acquired by the plant and usually arrives on a roll. Feedstock of various widths is acquired on one or more rolls from various sources including gypsum board plants or other paper product manufacturing plants. Next, the desired width and thickness of the laminated angle board sought to be manufactured is determined. The desired thickness of the final product is divided by the thickness of the scrap paper to determine the number of layers to be laminated together. The number of layers needed multiplied by the desired width gives the total width of scrap paper rolls desired. Scrap paper rolls of various widths are placed on the in-line slitter until enough strips, which will become layers, of the desired width can be cut. More than one in-line slitter may be used depending on the number of strips needed.

The in-line slitter of the preferred embodiment has adjustable knives which can be set to cut at the desired width. The knives of the in-line slitter can either be manually adjustable or automatically adjustable through the use of a computer. Once the knives are set, the process can begin. The desired number of strips begin coming directly off of the slitter already in the production process and move directly towards the cascading glue pot. As they approach the glue pot, they are brought together and aligned on top of each other. The strips then enter the glue pot where glue is placed typically on one side of each layer. Glue is the preferred adhesive, but other forms of adhesive, such as tape or epoxies, could be used to adhere the strips together. After leaving the glue pot, the strips pass through an alignment device and then are pressed together, or laminated, by the use of various rollers. At this point, the various strips of paper have been laminated into one piece of paper board. The flat board then enters a forming station where it is bent into a desired angle, preferably a right angle, along its length again by the use of rollers. The angle board then enters a cutting station where it is cut to a desired length.

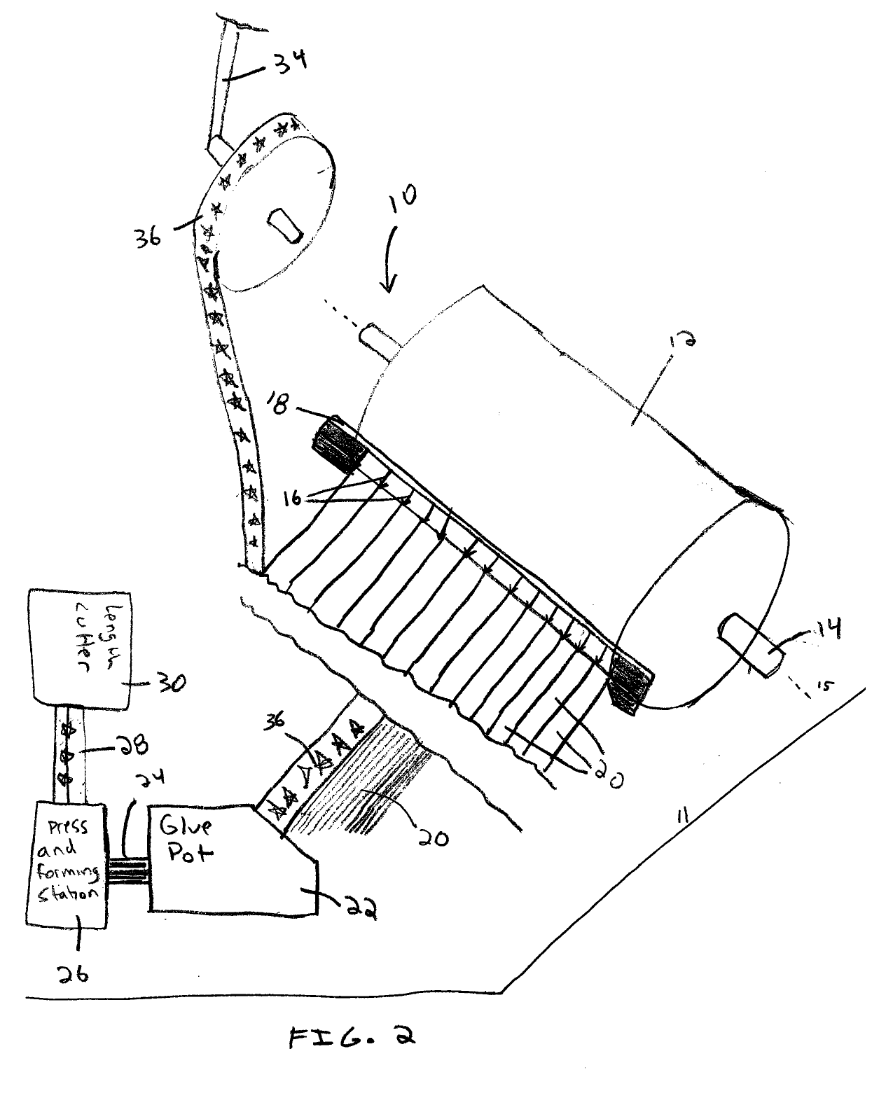

Referring to FIG. 2, the improved process is shown pictorially. In-line slitter 10 is shown disposed over a manufacturing floor 11. In-line slitter 10 is shown loaded with one roll of scrap paper 12. In-line slitter 10 can be any type of standard slitter used in the paper industry, and one of ordinary skill in the art will know the capabilities and set up mechanisms of slitter 10. Roll 12 is loaded onto in-line slitter 10 by placement on support rod 14, which can be fixed (not shown). Support rod 14 includes a longitudinal axis, which is disposed approximately horizontal with respect to the floor 11. A plurality of narrower rolls can be used in lieu of one wider roll 12 as shown. A plurality of knives 16 are adjustable along bar 18 so that strips 20 may be cut to the desired width. Bar 18 can be aligned such that knives 16 are placed on roll 12 so that a few thicknesses of the paper are slit before the paper is unrolled, and more are slit as it continues to be unrolled, rather than knives 16 cutting one layer of paper after it has been unrolled as is shown by FIG. 2. Printed strip 36, which is already the desired width, is shown on rack 34 beside slitter 10.

In the example shown, thirteen strips 20 and printed strip 36 are being laminated together. Strips 20 and printed strip 36 become aligned on top of each other as they move toward glue pot 22, which can take several feet. Glued strips 24 leave glue pot 22 and enter press and forming station 26 where glued strips 24 are pressed together into paper board and formed into a desired angle, preferably a right angle. Angle board 28 leaves press and forming station 26 and enters length cutter 30 where angle board 28 is cut to a desired length.

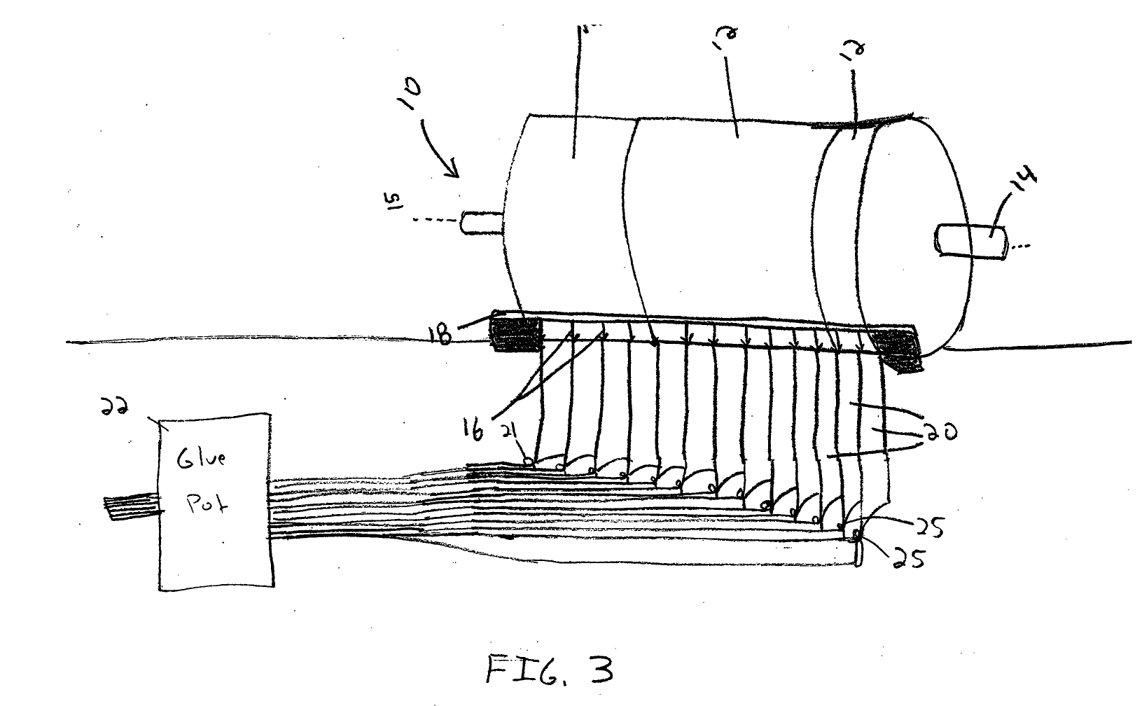

An additional embodiment is shown in FIG. 3, wherein in-line slitter 10 is perpendicular to the production line. Longitudinal axis 15 is still parallel with floor 11. Three rolls 12 are shown in this embodiment, but one wider roll could be used in lieu of narrower rolls 12. Strips 20 come off of in-line slitter 10 horizontally. Each strip 20 passes over a turn bar 25, which twists the paper from an approximately horizontal alignment to an approximately vertical alignment and turns strip 20 towards glue pot 22. After exiting turn bars 25, strips 20 gradually return to an approximately horizontal configuration and are in an approximately horizontal configuration before strips 20 enter glue pot 22. In this embodiment, turn bars 25 are arranged such that the distance strips 20 travel perpendicularly to the glue pot before turning is the distance that allows strips 20 to be aligned vertically on top of each after strips 20 return to an approximately horizontal configuration. This allows in-line slitter 10 to be placed much closer to glue pot 22 allowing the production line to be much shorter and saving floor space.

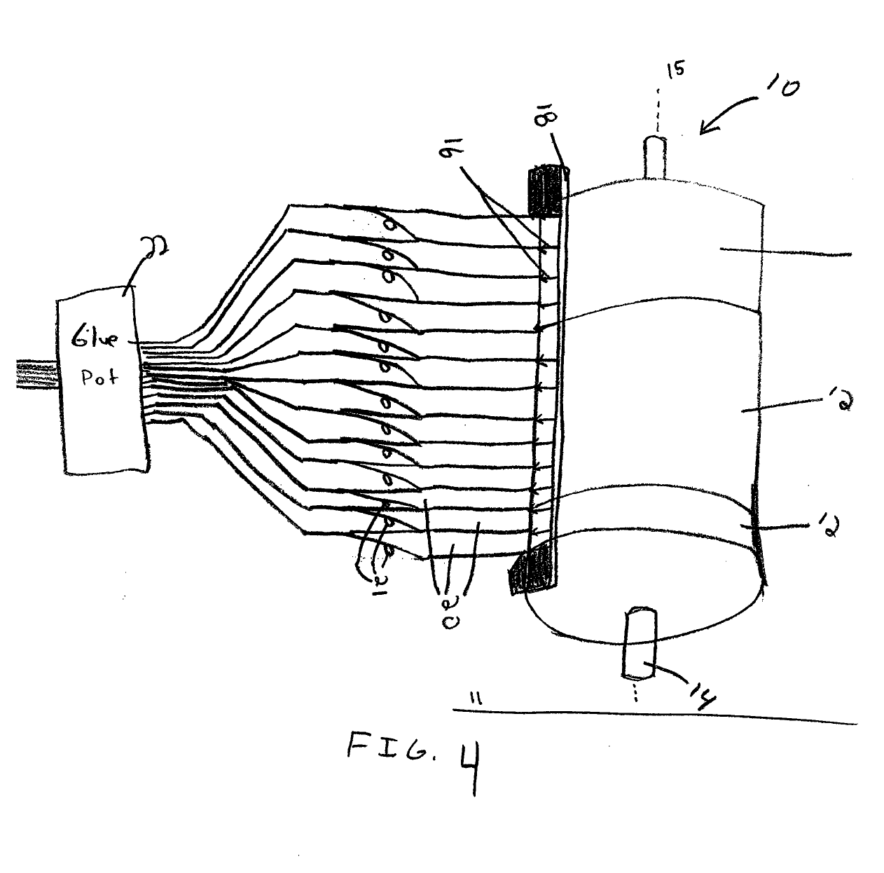

An additional embodiment is shown in FIG. 4, wherein in-line slitter 10 has been rotated approximately ninety degrees as compared to its disposition in FIG. 2 and is now approximately vertical. Longitudinal axis 15 is now approximately perpendicular to floor 11. Three rolls 12 are shown in this embodiment, but one wider roll could be used in lieu of narrower rolls 12. Strips 20 come off of in-line slitter 10 approximately vertically rather than approximately horizontally. Strips 20 pass over rollers 21 capable of rotating each paper strip from approximately a vertical configuration to approximately a horizontal configuration. In this embodiment, because strips 20 are aligned approximately vertically on top of each other, in-line slitter 10 may be placed much closer to glue pot 22. This allows the production line to be much shorter and saves floor space. In-line slitter 10 may also be rotated at any angle between zero and ninety degrees as long as strips 20 are aligned before entering glue pot 22. The closer in-line slitter 10 is rotated to approximately ninety degrees, the closer to glue pot 22 in-line slitter 10 can be placed. This configuration helps eliminate the need to move the strips 20 laterally to align them after cutting.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

1. A process for making laminated angle board comprising:
a slitter capable of cutting feedstock into a plurality of strips;
an adhesive station where adhesive is applied to the strips;
a means for pressing the plurality of strips into a board; and
wherein the slitter allows for cutting the feedstock into a plurality of strips that are fed directly into the adhesive station in an in-line process.

2. The process of claim 1 wherein the slitter is capable of cutting feedstock into a minimum of three strips.

3. The process of claim 1 further comprising the step of forming an angle into the board.

4. The process of claim 1 further comprising the step of cutting the board to a desired length.

5. The process of claim 1 wherein the adhesive station is a cascading glue pot.

6. The process of claim 1 wherein the means for pressing the plurality of strips into the paper board is by passing the plurality of layers between two rollers.

7. The process of claim 1 wherein the means for forming an angle into the paper board is by the use of a plurality of forming rolls.

8. The process of claim 7 wherein the forming rolls create approximately a ninety degree angle in the paper board.

9. The process of claim 1 further comprising an alignment plate wherein the plurality of strips is aligned after leaving the adhesive station.

10. The process of claim 1 wherein the slitter is horizontal.

11. The process of claim 1 wherein the slitter is placed approximately perpendicular to the in-line process.

12. The process of claim 11 further comprising the step of rotating the plurality of strips approximately ninety degrees and turning the plurality of strips towards the adhesive station.

13. The process of claim 1 wherein the slitter is approximately vertical.

14. The process of claim 13 further comprising the step of rotating the plurality of strips approximately ninety degrees such that they are disposed approximately horizontal.

15. The process of claim 1 wherein the feedstock is paper on a roll.

16. Laminated angle board made using the process of claim 1.

17. A novel slitting and paper-rotating apparatus for use in a process for making laminated angle board comprising:
a slitter orientated approximately vertically such that it is capable of slitting an approximately vertical roll of paper into a plurality of paper strips;
a plurality of rollers capable of rotating each paper strip from approximately a vertical configuration to approximately a horizontal configuration;
wherein the plurality of paper strips would be disposed approximately horizontally and aligned vertically after exiting the rollers.
